(19) United States
(12) Patent Application Publication
(10) Pub. No.: US 2019/0170910 A1
(43) Pub. Date: Jun. 6, 2019

(54) LIGHTWEIGHT SPECTACLE LENS

(71) Applicant: HON HAI PRECISION INDUSTRY CO., LTD., New Taipei (TW)

(72) Inventors: HSIU-WEN CHIEN, New Taipei (TW); WEN-KAI LI, New Taipei (TW)

(73) Assignee: HON HAI PRECISION INDUSTRY CO., LTD., New Taipei (TW)

(21) Appl. No.: 15/953,549

(22) Filed: Apr. 16, 2018

(30) Foreign Application Priority Data
Dec. 6, 2017 (CN) 201711279700.9

(51) Int. Cl. G02B 1/14; G02C 7/10; G02B 1/118; G02B 1/04

(52) U.S. Cl. CPC G02B 1/14; G02C 7/10; G02B 2207/101; G02B 1/041; G02B 1/118

(57) ABSTRACT

A lightweight spectacle lens is disclosed. The spectacle lens includes a lens main body, and the lens main body includes two surfaces opposite to each other; and a functional film formed on at least one surfaces of the lens main body, and a main material of the lens main body is cyclic block copolymer.

### FIELD

The subject matter herein generally relates to optical aids, and to a lens for spectacles.

### BACKGROUND

People with poor eyesight can wear glasses or contact lenses to see clearly. Contact lenses are convenient. However, human eyes will feel dry when contact lenses are worn for a long time, which can cause red-eye. Non-contact glass lenses are convenient, but are easily to crack and be scratched.

### BRIEF DESCRIPTION OF THE DRAWINGS

Implementations of the present technology will now be described, by way of example only, with reference to the attached figures.

FIG. 1 is a cross-sectional view of a spectacle lens in accordance with one exemplary embodiment.

FIG. 2 is a cross-sectional view of a spectacle lens in accordance with one exemplary embodiment.

FIG. 3 is a cross-sectional view of a spectacle lens in accordance with one exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

### Example 1

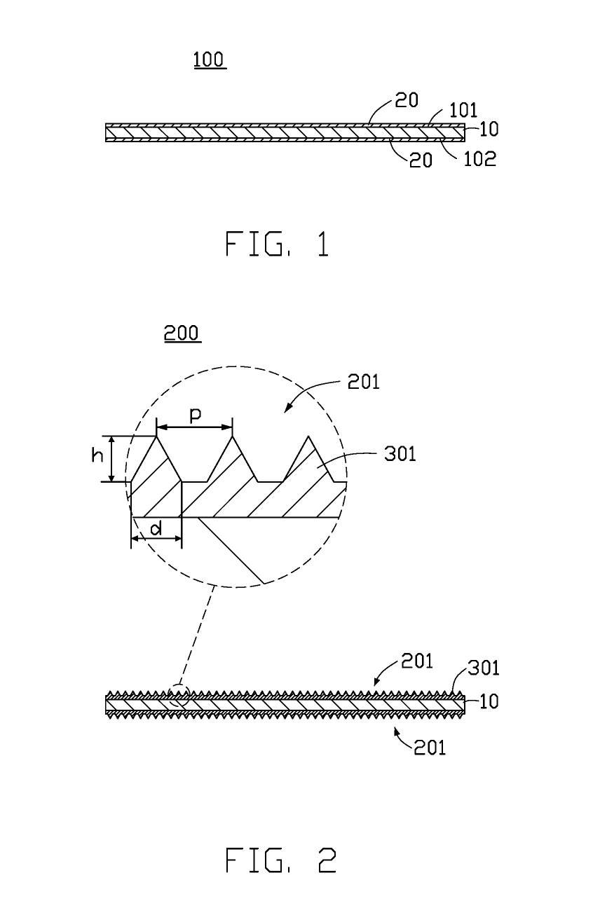

FIG. 1 illustrates a lightweight spectacle lens 100 according to one embodiment. The spectacle lens 100 includes a lens main body 10 and a functional film 20 formed on at least one surfaces of the lens main body 10. A main material of the lens main body is cyclic block copolymer (CBC). This material allows the spectacle lens 100 to have lightweight performance.

In the illustrated embodiment, and the lens main body 10 includes a front surface 101 and a rear surface 102 opposite to the front surface 101, and the functional film 20 formed on both the front surface 101 and the rear surface 102.

The front surface 101 is a spherical surface, a non spherical surface, or a progressive surface, and the back surface 102 is a spherical surface, an aspheric surface, or a progressive surface.

The functional film 20 is select from a group consisting of a rigid film, an anti-smear film (to reduce fingerprints), an anti fogging film, a color film, a waterproof self cleaning film, an anti ultraviolet film and an anti reflection film or any combination thereof. That is, a rigid film, an anti-smear film, an anti fogging film, a color film, a waterproof self cleaning film, an anti ultraviolet film and an anti reflection film can successively formed on one surface of the lens main body 10 according to the functional requirements.

In the illustrated embodiment, the functional film 20 is a single rigid film. The rigid film has a high surface hardness and a strong adhesive strength. A high surface hardness means a high scratch resistance, and the rigid film protects the lightweight spectacle lens 100 from scratches. The rigid film is composed of a dopamine, a plurality of inorganic oxide particles, and a solvent. The rigid film is formed by coating a mixture of a dopamine, and a plurality of inorganic oxide particles on surfaces of the spectacle lens 100.

The dopamine has a mass percentage of about 1% to about 40% of a total mass of the hard coating composition, the plurality of the inorganic oxide particles has a mass percentage of about 40% to about 80% of the total mass of the hard coating composition. The solvent has a mass percentage of about 5% to about 50% of the total mass of the hard coating composition.

The plurality of inorganic oxide particles is selected from particles of silica, zirconia, alumina, titanium, or any combination thereof. Particle diameter of the inorganic oxide particle is about 1 nm to about 1000 nm.

The solvent is water, an alcohol aqueous solution, or an oxidizing aqueous solution. The alcohol aqueous solution is a methanol aqueous solution, an ethanol aqueous solution, or a propanol aqueous solution, and the oxidizing aqueous solution is sodium periodate aqueous solution.

In a preferred embodiment, an ultraviolet absorbers is doped with the circular block copolymers to form an anti-ultraviolet glasses, and a weight ratio of the ultraviolet absorbers in a total weight of the circular block copolymers and the ultraviolet absorbers is 0.0003% and 5.8%. This allows the spectacle lens 100 to have strong ultraviolet-blocking property, lower risk of breaking, and better shock resistance.

The spectacle lens can be single focus, bi-focus, or multi-focus lens.

The spectacle lenses can be employed as corrective lens, such as myopia lens, hypermetropia lenses, presbyopic lens, or progressive lens.

### Example 2

FIG. 2 illustrates a lightweight spectacle lens 200 according to one embodiment. The lightweight spectacle lens 200 in FIG. 2 is similar to the lightweight spectacle lens 100 in FIG. 1. The difference between the lightweight spectacle lens 200 and the lightweight spectacle lens 100 in FIG. 1 is that the functional film includes an anti reflection film 201, the an anti reflection film 201 includes a plurality of micro-structures 301 spacing apart, and the size of the microstructure 301 is in nanometer magnitude.

In the illustrated embodiment, as shown in FIG. 2, a section of the microstructure 202 is triangular. A height of the microstructure is in a range from 40 nm to 550 nm, a width of the microstructure is in a range from 35 nm to 555 nm, a period of the microstructures is in a range from 10 nm to 650 nm. The scale of microstructure is no greater than the wavelength of light.

When the scale of the microstructure 301 is no larger than the wavelength of light, refraction of light wave will present a continuous change on the surface of the microstructure (graded index of gradual index of refraction), and this continuous change can achieve the anti reflection characteristics and increase the absorption of optical structure to light. Thereby, the microstructure 301 absorb light from all directions. And because the surface of the anti-reflection film 201 is microstructure 301, and the lightweight spectacle lens 200 has super-hydrophobicity and self-cleaning property, similarly to the lotus effect. The anti reflection film 201 is formed on surfaces of the lens main body 10 by a sol-gel method.

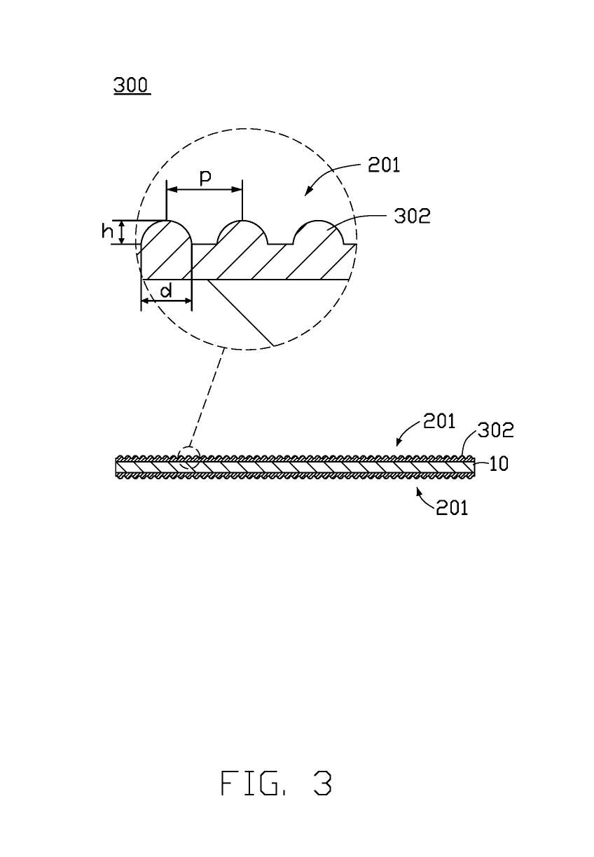

FIG. 3 illustrates a lightweight spectacle lens 300 according to one embodiment. The lightweight spectacle lens 300 in FIG. 3 is similar to the lightweight spectacle lens 200 in FIG. 2. The difference between the lightweight spectacle lens 300 and the lightweight spectacle lens 200 in FIG. 2 is that the a section of the microstructure 302 is semicircle.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A lightweight spectacle lens comprising:
a lens main body comprising two surfaces opposite to each other;
and a functional film formed on at least one surfaces of the lens main body, wherein a main material of the lens main body is cyclic block copolymer.

2. The lightweight spectacle lens of claim 1, wherein the two surfaces is a front surface and a rear surface, the front surface is a spherical surface, a non spherical surface, or a progressive surface, and the back surface is a spherical surface, an aspheric surface, or a progressive surface.

3. The lightweight spectacle lens of claim 1, wherein the functional film is select from a group consisting of a rigid film, an anti-smear film, an anti fogging film, a color film, a waterproof self cleaning film, and an anti reflection film or any combination thereof.

4. The lightweight spectacle lens of claim 1, wherein an ultraviolet absorbers is doped with the circular block copolymers to form an anti-ultraviolet glasses, and a weight ratio of the ultraviolet absorbers in a total weight of the circular block copolymers and the ultraviolet absorbers is 0.0003% and 5.8%.

5. The lightweight spectacle lens of claim 1, wherein the ultraviolet absorbers is select from UV-326, UV-329, or UV-531.

6. The lightweight spectacle lens of claim 1, wherein the functional film comprises a rigid film, and the rigid film is composed of a dopamine, a plurality of inorganic oxide particles, and a solvent.

7. The lightweight spectacle lens of claim 6, wherein the dopamine has a mass percentage of about 1% to about 40% of a total mass of the hard coating composition, the plurality of the inorganic oxide particles has a mass percentage of about 40% to about 80% of the total mass of the hard coating composition, the solvent has a mass percentage of about 5% to about 50% of the total mass of the hard coating composition.

8. The lightweight spectacle lens of claim 7, wherein the plurality of inorganic oxide particles is selected from particles of silica, zirconia, alumina, titanium, or any combination thereof.

9. The lightweight spectacle lens of claim 8, wherein a particle diameter of the inorganic oxide particle is about 1 nm to about 1000 nm.

10. The lightweight spectacle lens of claim 9, wherein the solvent is water, an alcohol aqueous solution, or an oxidizing aqueous solution.

11. The lightweight spectacle lens of claim 10, wherein the alcohol aqueous solution is a methanol aqueous solution, an ethanol aqueous solution, or a propanol aqueous solution, and the oxidizing aqueous solution is sodium periodate aqueous solution.

12. The lightweight spectacle lens of claim 3, wherein the functional film comprises an anti reflection film, the an anti reflection film comprises a plurality of micro-structures spacing apart, and the size of the microstructure is in nanometer magnitude.

13. The lightweight spectacle lens of claim 12, wherein a section of the microstructure is triangular or semicircular.

14. The lightweight spectacle lens of claim 13, wherein a height of the microstructure is in a range from 40 nm to 550 nm, a width of the microstructure is in a range from 35 nm to 555 nm, a period of the microstructures is in a range from 10 nm to 650 nm.
